(19) United States
(12) Patent Application Publication
(10) Pub. No.: US 2016/0335501 A1
(43) Pub. Date: Nov. 17, 2016

(54) SURVEILLANCE DEVICE, SYSTEM AND METHOD THEREOF

(71) Applicant: AETEK INC., NEW TAIPEI CITY (TW)

(72) Inventor: SHENG-PIN HUANG, NEW TAIPEI CITY (TW)

(21) Appl. No.: 14/712,981

(22) Filed: May 15, 2015

(51) Int. Cl. G06K 9/00; H04N 5/247; H04N 5/232; H04N 5/225

(52) U.S. Cl. CPC G06K 9/00771; H04N 5/2256; H04N 5/247; H04N 5/2252; H04N 5/23206

(57) ABSTRACT

A surveillance device including a processing module, a lighting module, a movable module, a first camera module and a second camera module. The lighting module is coupled to the processing module to emit light and illuminate a surrounding environment. The movable module is coupled to the processing module. The first camera module is coupled to the processing module. The second camera module is coupled to the processing module, and is disposed on the movable module. When the processing module determines that the amount of light received by the first camera module is lower than a predetermined value, the processing module controls the lighting module to emit light. The processing module uses the movable module to control the second camera module to face towards a direction to the surrounding environment so that the second camera module acquires an image of the surrounding environment.

### BACKGROUND

1. Technical Field

The present invention generally relates to a surveillance device, a system and a method thereof and, more particularly, to a real-time surveillance device, a system and a method thereof.

2. Description of Related Art

The currently available dome-shaped surveillance devices (or surveillance cameras) are mostly installed on the ceiling, the wall, or around the corner. The dome-shaped surveillance devices are able to record a video with a predetermined shooting angle after the camera lens has been adjusted. However, if one desires to change the shooting angle while recording, the dome-shaped surveillance device has to be uninstalled or the cap of the dome-shaped surveillance device has to be removed, which is inconvenient and time-consuming.

If the dome-shaped surveillance device is provided with a step motor therein, the camera lens of the dome-shaped surveillance device can move freely to control the shooting angle of the dome-shaped surveillance device. However, some video sections of the targeted scene will be missing because the camera lens of the dome-shaped surveillance device may move freely, which causes uncertainty in surveillance and security. Moreover, when the step motor breaks down or is damaged, the camera lens of the dome-shaped surveillance device may turn to face towards some secondary spots, which also causes uncertainty in surveillance and security.

### SUMMARY

The present invention aims at providing a surveillance device, a system and a method thereof to statically acquire a full view image of a surrounding environment and to dynamically acquire a local image of the surrounding environment so as to improve surveillance and security.

The present invention provides a surveillance device including a processing module, a lighting module, a movable module, a first camera module and a second camera module. The lighting module is coupled to the processing module to emit light and illuminate a surrounding environment. The movable module is coupled to the processing module. The first camera module is coupled to the processing module. The second camera module is coupled to the processing module, and is disposed on the movable module. When the processing module determines that an amount of light received by the first camera module is lower than a predetermined value, the processing module controls the lighting module to emit light. The processing module uses the movable module to control the second camera module to face towards a direction to the surrounding environment so that the second camera module acquires an image of the surrounding environment.

The present invention provides a surveillance system including a host and a plurality of surveillance devices. The host is coupled to a network. The plurality of surveillance devices are coupled to the host. The plurality of surveillance devices are disposed, respectively, in a plurality of zones in a surveillance environment. When one of the plurality of surveillance devices detects an object, the one of the plurality of surveillance devices that detects the object outputs a detection signal to the host so that the host controls the plurality of surveillance devices, respectively, to surveil the object according to a moving path of the object.

The present invention provides a surveillance method for a surveillance device. The surveillance device includes a processing module, a lighting module, a movable module, a first camera module and a second camera module. The processing module is coupled to the lighting module, the movable module, the first camera module and the second camera module. The surveillance method includes the steps herein. Whether the amount of light received by the first camera module is lower than a predetermined value is determined. When the amount of light received by the first camera module is lower than the predetermined value, the processing module controls the lighting module to emit light and the processing module uses the movable module to control the second camera module to face towards a direction to the surrounding environment so that the second camera module acquires an image of the surrounding environment. Otherwise, when the amount of light received by the first camera module is higher than the predetermined value, the processing module controls the lighting module not to emit light and the processing module uses the movable module to control the second camera module to face towards the direction to the surrounding environment so that the second camera module acquires the image of the surrounding environment.

The present invention uses a first camera module and a second camera module to statically acquire a full view image of a surrounding environment and to dynamically acquire a local image of the surrounding environment. When the amount of light received by the first camera module is lower than a predetermined value, the lighting module transmits infrared light waves to the surrounding environment so that the first and second camera modules acquire the full view image and the local image in the night time or under conditions of insufficient light. More particularly, the surrounding environment or the object in the full view image can be enlarged in the local image. Accordingly, surveillance and security can be enhanced with the use of the present invention.

In order to further understand the techniques, means and effects of the present disclosure, the following detailed descriptions and appended drawings are hereby referred to, such that, and through which, the purposes, features and aspects of the present disclosure can be thoroughly and concretely appreciated; however, the appended drawings are merely provided for reference and illustration, without any intention to be used for limiting the present disclosure.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1 is a block diagram of a surveillance device according to one embodiment of the present invention;

FIG. 2 is a perspective view of a surveillance device according to one embodiment of the present invention.

FIG. 3A is a cutaway view of a surveillance device according to one embodiment of the present invention;

FIG. 3B is a cutaway view of a first camera module in FIG. 3A according to one embodiment of the present invention;

FIG. 4 is a schematic view of how a surveillance device operates according to one embodiment of the present invention;

FIG. 5 is a schematic view of how a surveillance system operates according to one embodiment of the present invention; and

FIG. 6 is a flowchart of a surveillance method according to one embodiment of the present invention.

### DESCRIPTION OF THE EXEMPLARY EMBODIMENTS

Reference will now be made in detail to the exemplary embodiments of the present disclosure, examples of which are illustrated in the accompanying drawings. Wherever possible, the same reference numbers are used in the drawings and the description to refer to the same or like parts.

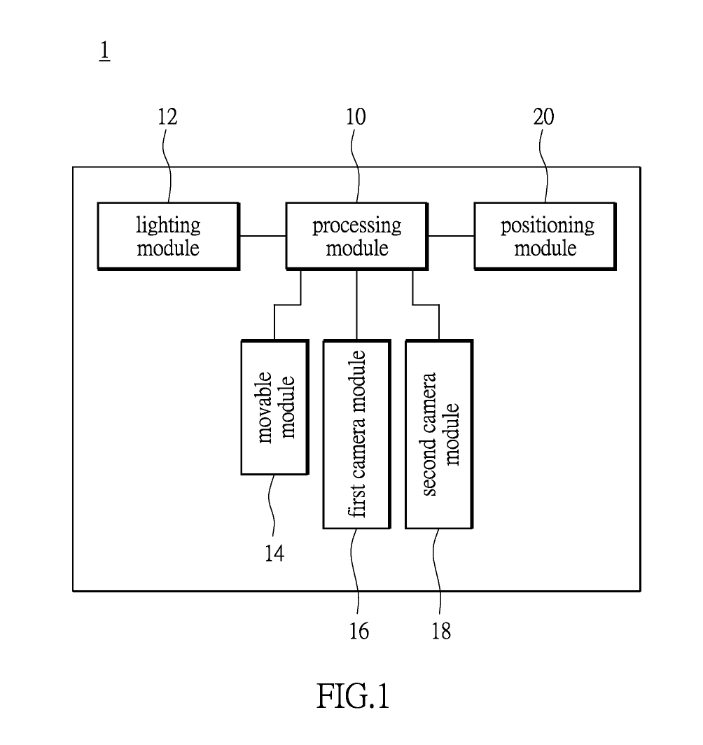

FIG. 1 is a block diagram of a surveillance device according to one embodiment of the present invention. With reference to FIG. 1, the surveillance device 1 includes a processing module 10, a lighting module 12, a movable module 14, a first camera module 16, a second camera module 18 and a positioning module 20. Practically, the processing module 10 is coupled to the lighting module 12, the movable module 14, the first camera module 16, the second camera module 18 and the positioning module 20. More particularly, the processing module 10 controls the lighting module 12 to emit light. The processing module 10 uses the movable module 14 to control the second camera module 18 to face towards a direction to the surrounding environment so that the second camera module 18 acquires an image of the surrounding environment.

To make it more clearly understood, in the present embodiment, the first camera module 16 is, for example, a fish-eye camera lens for acquiring a full view image, and the second camera module 18 is, for example, a zoom camera lens for acquiring a local image. Accordingly, the surveillance device 1 uses the first camera module 16 to acquire a full view image of the surveillance environment and uses the second camera module 18 to acquire a local image of the surveillance environment. The present invention is, however, not limited to the previous examples of the surveillance device 1. More particularly, the processing module 10 is, for example, a central processing unit, a microprocessor, a controller or a logic circuit. Practically, the processing module 10 is capable of calculating or processing signals generated by or transmitted between modules. The present invention is, however, not limited to the previous examples of the processing module 10.

Moreover, the processing module 10 is provided with a positioned cruising mode, a cruising mode and a non-cruising mode. The processing module 10 controls the movable module 14 to move or rotate according to the positioned cruising mode, the cruising mode or the non-cruising mode so that the second camera module 18 faces towards the surrounding environment.

Furthermore, in the cruising mode, the movable module 14 cruises at a high speed, at an intermediate speed, at a low speed or at other speeds. Accordingly, the second camera module 18 is in a dynamically cruising state. In the positioned cruising mode, the movable module 14 cruises with respect to a plurality of fixed positions or a specific fixed position. Moreover, in the non-cruising mode, the normal mode or other modes, the movable module 14 is in a standby state, a sleep state or an idle state. The present invention is, however, not limited to the previous examples of the positioned cruising mode, the cruising mode and the non-cruising mode.

To make it more clearly understood, in the present embodiment, the lighting module 12 is, for example, an infrared (IR) transmitter. In other embodiments, the lighting module 12 is, for example, a white light transmitter, a yellow light transmitter, a blue light transmitter or a green light transmitter. The present invention is, however, not limited to the previous examples of the lighting module 12. Furthermore, the lighting module 12 is coupled to the processing module 10 to emit light and illuminate a surrounding environment. The lighting module 12 transmits light waves to the surrounding environment. The first camera module 16 receives the light waves reflected by the surrounding environment and issues a first image signal to the processing module 10.

In other words, the lighting module 12 and the first camera module 16 are viewed as active infrared sensors. The infrared (IR) transmitter continues to issue infrared light waves to the surrounding environment. When the first camera module 16 receives the reflected infrared light waves, the first camera module 16 acquires a first image signal of the surrounding environment or the object. Similarly, when the second camera module 18 receives the reflected infrared light waves, the second camera module 18 acquires a second image signal of the surrounding environment or the object. Accordingly, the first and second camera modules 16, 18 are able to acquire an image of the surrounding environment or the object.

The movable module 14 is coupled to the processing module 10. Practically, the movable module 14 includes a first rotation unit 141 and a second rotation unit 142. The first rotation unit 141 rotates clockwise or counter clockwise with respect to the support C1 as a rotational axis so that the second camera module 18 moves or rotates with respect to the support C1. The second rotation unit 142 rotates upwards or downwards so that the second camera module 18 rotates upwards or downwards.

In other words, the movable module 14 moves in a three-dimensional fashion. The movable module 14 is implemented by, for example, a PT (Pan/Tilt) platform. In other words, the movable module 14 uses the first rotation unit 141 to rotate clockwise or counter clockwise. The movable module 14 uses the second rotation unit 142 to rotate upwards or downwards. The present invention is, however, not limited to the previous examples of the movable module 14.

The first and second camera module 16, 18 are coupled to the processing module 10. Practically, the first camera module 16 acquires a full view image of the surrounding environment. The second camera module 18 zooms to acquire a local image of the surrounding environment. The first camera module 16 is provided with a first shooting angle. The second camera module 18 is provided with a second shooting angle. The first shooting angle is wider than the second shooting angle. The first camera module 16 is at a fixed position to acquire the full view image. The second camera module 18 is at a dynamic position with a zoom camera lens to acquire the local image.

It should be noted that the second camera module 18 is disposed on the movable module 14. The second camera module 18 is provided with a zoom camera lens to enlarge the local image in the full view image. Moreover, the processing module 10 controls the movable module 14 and the second camera module 18 according to a targeted object to trace the object and acquire the image of the object. For example, when the targeted object is a basketball, the processing module 10 controls the movable module 14 and the second camera module 18 according to the movement of the basketball to trace the basketball and acquire the image of the basketball in the surrounding environment.

The positioning module 20 is coupled to the processing module 10. Practically, the positioning module 20 is provided with a reference origin. The movable module 14 is implemented by, for example, a step motor. The positioning module 20 is implemented by, for example, positioning software or positioning firmware that is able to control the step motor. Accordingly, the processing module 10 controls the movable module 14 according to the reference origin and the coordinate of the step motor.

In other embodiments, the positioning module 20 can also be implemented by a gyroscope. The gyroscope is disposed on the second camera module 18. Accordingly, the positioning module 20 outputs a positioning signal to the processing module 10 according to the position of the second camera module 18 so that the processing module 10 acquires the position of second camera module 18. The present invention is, however, not limited to the previous examples of the positioning module 20.

It should be noted that, in other embodiments, the surveillance device 1 may further include a sensor module (not shown). The sensor module is implemented, for example, by an infrared (IR) sensor, a microwave sensor or a laser sensor. The sensor module senses or detects the object. Upon sensing the object, the sensor module outputs a sensing signal to the processing module 10 so as to activate the lighting module 12 to emit light. The person with ordinary skill in the art should know the infrared (IR) sensor, the microwave sensor or the laser sensor. The present invention is, however, not limited to the previous examples of the sensor module.

As stated above, in the night time or under conditions of insufficient light, a general surveillance device may fail to acquire the image of the surrounding environment or the object. Accordingly, when the processing module 10 determines that the amount of light received by the first camera module 16 is lower than a predetermined value, the processing module 10 activates the lighting module 12. The processing module 10 controls the movable module 14 to move or rotate so that the second camera module 18 faces towards the surrounding environment. The processing module 10 controls the lighting module 12 to emit light to illuminate the surrounding environment the second camera module 18 faces towards. The second camera module 18 zooms to acquire the image of the surrounding environment.

Moreover, the predetermined value is, for example, an amount of light between that in the day time and that in the night time. The person with ordinary skill in the art may decide the predetermined value. In other words, when the amount of light is higher than or equal to the predetermined value, the lighting module 12 does not emit light. On the contrary, when the amount of light is lower than the predetermined value, the lighting module 12 emits light. Accordingly, in the present embodiment, the first and the second camera modules 16, 18 may acquire the full view image and the local image in the night time or under conditions of insufficient light. The present invention is, however, not limited to the previous examples of how the surveillance device 1 operates.

In the following, the structure and operation of the surveillance device 1 will be described in more detail.

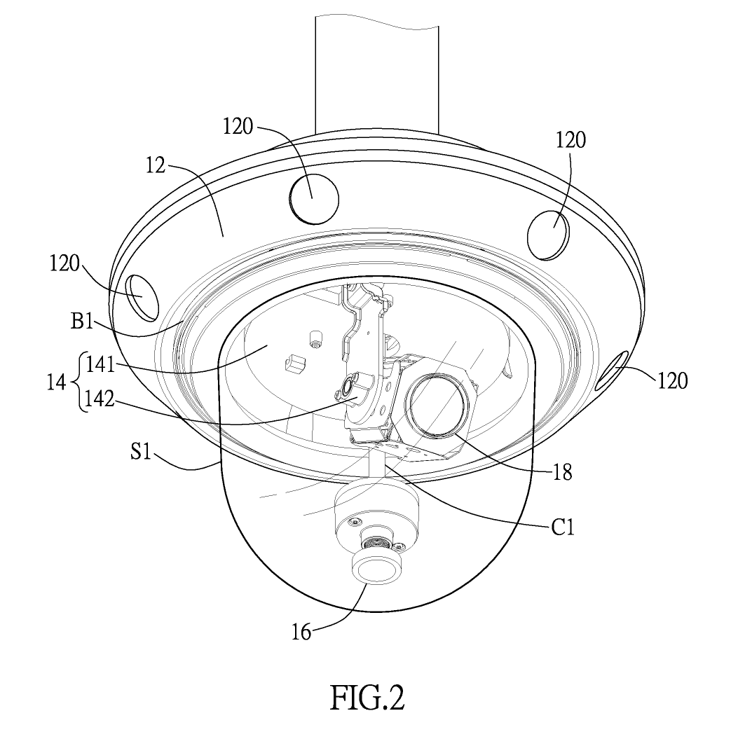

FIG. 2 is a perspective view of a surveillance device according to one embodiment of the present invention. With reference to FIG. 2, the surveillance device 1 further includes a base B1, a support C1 and a cover S1. The processing module 10 and part of the movable module 14 in FIG. 1 are disposed in a capacity space BS inside the base B1.

More particularly, the base B1 is, for example, a body of the surveillance device 1. The base B1 includes a fixing structure (not shown) so that the base B1 can be fixedly connected to the wall, the ceiling or a designated position. The base B1 is implemented, for example, using plastic, metal, wood and/or other materials. Practically, a lighting module 12 is disposed on an outer side of the base B1. In other words, the lighting module 12 surrounds and is disposed on the outer side of the base B1. The present invention is, however, not limited to the previous examples of the base B1.

To make it more clearly understood, in the present embodiment, the support C1 is disposed at the center of the base B1. The support C1 is connected to the base B1. Practically, the support C1 is, for example, a hollow cylinder. The support C1 is connected to the base B1 at one end and to the first camera module 16 at the other end. In other words, the first camera module 16 is a camera lens fixedly disposed on top of the support C1.

The cover S1 is connected to the base B1 and the cover S1 encloses a compartment to accommodate the first camera module 16, the second camera module 18 and the movable module 14. Practically, the cover S1 is implemented, for example, using plastic, glass or sapphire. The cover S1 includes, for example, transparent materials. Accordingly, the first and the second camera modules 16, 18 are able to acquire the full view image and the local image, respectively, of the surrounding environment. The present invention is, however, not limited to the previous examples of the cover S1.

Moreover, the first rotation unit 141 is implemented, for example, by a rotating disk and rotating mechanism thereof. Thereby, the second camera module 18 rotates clockwise or counter clockwise with the rotating disk and rotating mechanism thereof. The second rotation unit 142 is implemented, for example, by a supporting arm, a rotating shaft and a gear thereon. The supporting arm is connected to the rotating disk. Thereby, the second camera module 18 rotates upwards or downwards with the rotating shaft and the gear thereon. The present invention is, however, not limited to the previous examples of the first and the second rotation units 141, 142.

For example, in the night time or under conditions of insufficient light, when the processing module 10 determines that the amount of light received by the first camera module 16 is lower than a predetermined value, the processing module 10 activates the lighting module 12. The processing module 10 controls the movable module 14 to move or rotate so that the second camera module 18 faces towards the surrounding environment. The lighting module 12 in the present embodiment continues to transmit infrared light waves to illuminate the surrounding environment. The second camera module 18 zooms to acquire the image of the surrounding environment.

It should be noted that the lighting module 12 includes a plurality of light-emitting units 120 such as infrared transmitters. The plurality of light-emitting units 120 are disposed on the outer side of the base B1. The processing module 10 controls some of the light-emitting units corresponding to the position of the second camera module 18 to emit light according to the position of the second camera module 18.

Taking a 360° circular base B1 for example, 12 light-emitting units 120 such as infrared transmitters are disposed every 30° on the outer side of the base B1. The processing module 10 controls the movable module 14 to move or rotate so that the second camera module 18 performs a cruising or a non-cruising operation. When the second camera module 18 moves, for example, to the position at 270°, the processing module 10 controls the light-emitting unit 120 on the position at 270° to transmit infrared light waves, or the processing module 10 controls the light-emitting unit 120 on the position at 270° plus/minus 30° to transmit infrared light waves.

In other words, the second camera module 18 uses the movable module 14 to move or rotate to a designated position. The lighting module 12 corresponding to the designated position transmits light waves to the surrounding environment. Accordingly, the second camera module 18 zooms to acquire an image of the surrounding environment. In other embodiments, the lighting module 12 is, for example, “a light emitter capable of moving or rotating on the outer side of the base B1” and corresponds to the designated position to transmit light waves to the surrounding environment.

It should be noted that, in other embodiments, the lighting module 12 is disposed, for example, on the outer side of the base B1 and each of the light-emitting units 120 includes, for example, a plurality of light-emitting elements such as infrared (IR) light bulbs, yellow light bulbs and blue light bulbs. Thereby, the processing module 10 controls the lighting module 12 to transmit light waves to illuminate the object. Accordingly, the first and the second camera modules 16, 18 may acquire the image of the surrounding environment or the object.

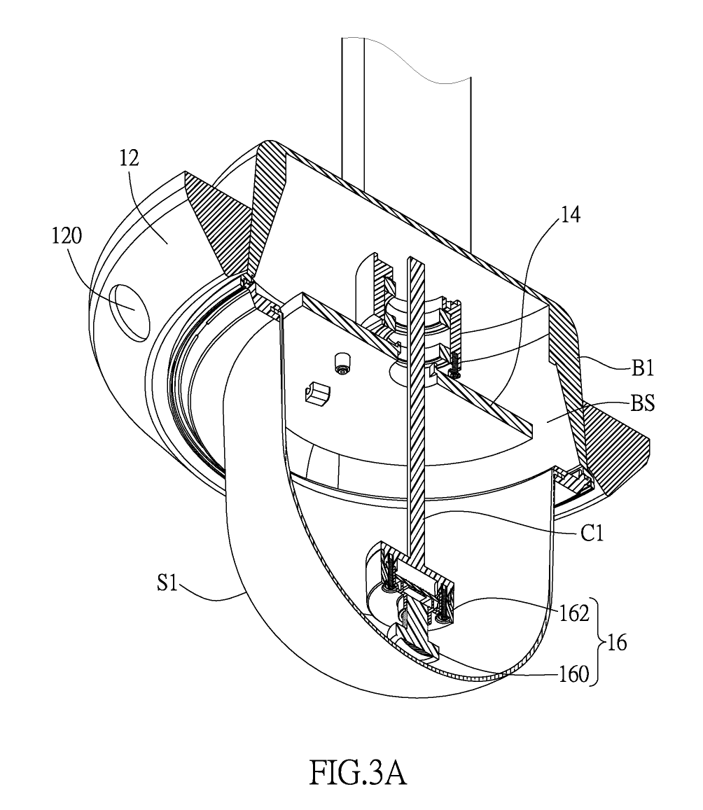

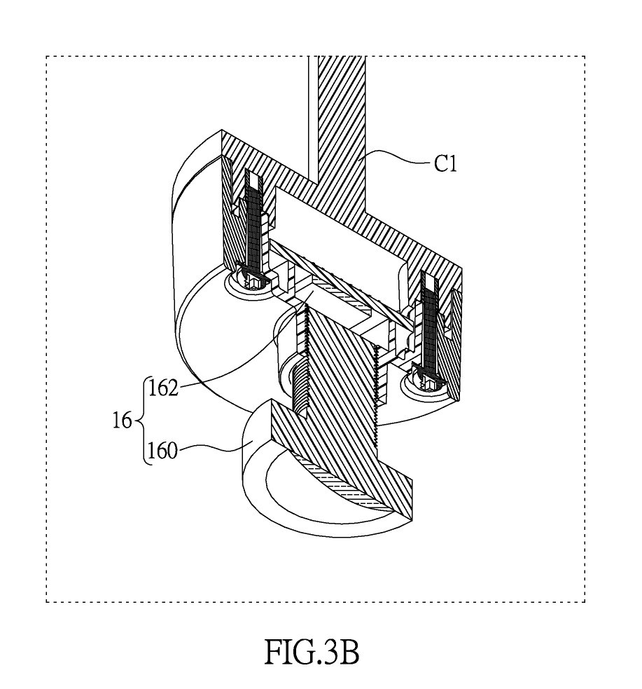

FIG. 3A is a cutaway view of a surveillance device according to one embodiment of the present invention and FIG. 3B is a cutaway view of a first camera module in FIG. 3A according to one embodiment of the present invention. With reference to FIG. 3B, a first camera module 16 is illustrated.

Practically, the first camera module 16 includes a fish-eye unit 160 and a filter switching unit 162. The fish-eye unit 160 is connected to the filter switching unit 162. The processing module 10 controls the filter switching unit 162 to block infrared (IR) from entering when light with the amount being higher than or equal to the predetermined value enters the fish-eye unit 160. The processing module 10 controls the filter switching unit 162 to allow infrared (IR) to enter when light with an amount being lower than the predetermined value enters the fish-eye unit 160. In other words, when the light in the day time enters the fish-eye unit 160, the processing module 10 controls the filter switching unit 162 to block infrared (IR) from entering. After the light in the night time enters the fish-eye unit 160, the processing module 10 controls the filter switching unit 162 to allow infrared (IR) to enter.

Furthermore, the filter switching unit 162 is implemented, for example, by an IR-cut dual-filter switch. The filter switching unit 162 performs, on the first camera module 16, a correction for color cast during the day time and enhances the brightness in the night time. The IR-cut dual-filter switch includes a filter and a driving element. The filter is implemented, for example, by an IR-cut filter or an IR-absorbing filter and a full spectrum filter. The driving element is implemented, for example, by an electromechanism, electromagnetism or other mechanisms. The present invention is, however, not limited to the previous examples of the filter switching unit 162.

For example, the IR-cut filter works and the charge-coupled device (CCD) renders true colors of the object in sufficient light during the day time. During the night time or under conditions of insufficient light, the IR-cut filter is removed and the full spectrum filter works so that the CCD can take advantage of all the light to improve the low light performance. Similarly, the second camera module 18 also includes a filter switching unit. In the present embodiment, the first camera module 16 determines whether the amount of light is lower than the predetermined value.

Next, the detailed operations and applications of the surveillance device 1 will be described herein.

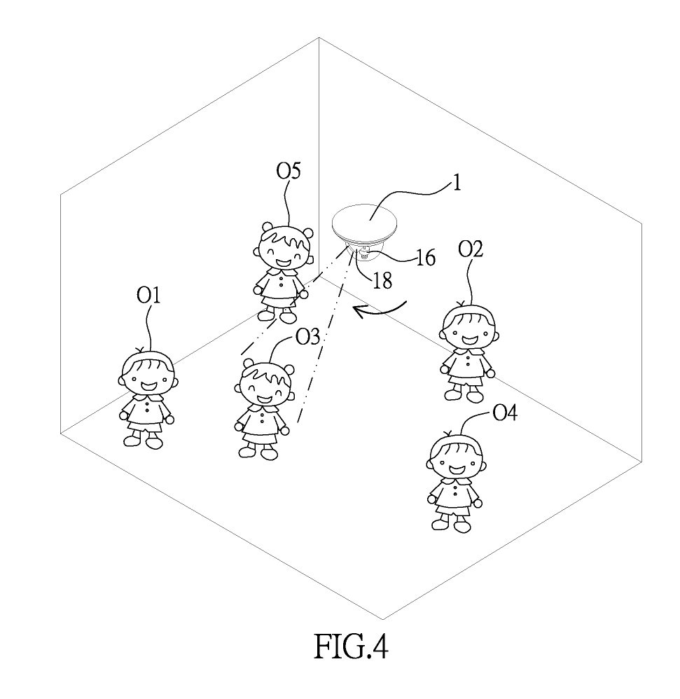

FIG. 4 is a schematic view of how a surveillance device operates according to one embodiment of the present invention. To make it more clearly understood, referring to FIG. 4, the surveillance device 1 in the present embodiment is installed in a classroom in a kindergarten. Five children O1˜O5 are in the classroom.

For example, the first camera module 16 acquires the full view image in the classroom. More particularly, the child O2 is, for example, at the position of the reference origin of the movable module. The other children O4, O3, O1, and O5 are, respectively, at the positions being 30°, 120°, 150° and 210° with respect to the reference origin. The processing module is, for example, in the positioned cruising mode to trace each of the five children O1˜O5 in turn. Certainly, each of the five children O1˜O5 may freely move to change the positions in the classroom.

In other words, each of the five children O1˜O5 is traced by the second camera module 18 for 5 seconds to acquire an enlarged image thereof. Moreover, in the positioned cruising mode, the children O1˜O5 are traced from the child O1 to the child O5. Simply put, the second camera module 18 traces the child O2 after tracing the child O1. Similarly, the second camera module 18 traces the child O4 after tracing the child O3. Similarly, the second camera module 18 traces the child O1 after tracing the child O5. The present invention is, however, not limited to the previous examples of the positioned cruising mode.

For example, the first camera module 16 acquires the full view image in the classroom. The processing module acquires the position of the child O2 from the full view image. Thereby, the processing module controls the movable module to move to an angle corresponding to the position of the child O2 and controls the second camera module 18 to zoom to acquire the image of the child O2. Five seconds later, the processing module acquires the position of the child O3 from the full view image in the classroom acquired by the first camera module 16. Thereby, the processing module controls the movable module to move to an angle corresponding to the position of the child O3 and controls second camera module 18 to zoom to acquire the image of the child O3. The first rotation unit of the movable module rotates clockwise to a position corresponding to an angle of 120°. The second rotation unit rotates downwards.

Five seconds later, the processing module acquires the position of the child O4 from the full view image in the classroom acquired by the first camera module 16. Thereby, the processing module controls the movable module to move to an angle corresponding to the position of the child O4 and controls the second camera module 18 to zoom to acquire the image of the child O4. The first rotation unit of the movable module rotates counter clockwise to a position corresponding to an angle of 30°. The second rotation unit rotates upwards.

Similarly, 5 seconds later, the processing module acquires the position of the child O5 from the full view image in the classroom acquired by the first camera module 16. Thereby, the processing module controls the movable module to move to an angle corresponding to the position of the child O5 and controls the second camera module 18 to zoom to acquire the image of the child O5. The first rotation unit of the movable module rotates clockwise to a position corresponding to an angle of 210°. The second rotation unit rotates downwards.

In other embodiments, the surveillance device 1 can also be disposed in a football stadium, a basketball stadium or other places. The first camera module 16 acquires the full view image, and the second camera module 18 zooms, traces and acquires the local image of the football in the football stadium or the local image of the basketball in the basketball stadium. Simply put, in the present embodiment, the first camera module 16 acquires the full view image and the second camera module 18 traces the object and acquires the local image of the object in the surrounding environment. The object can be, for example, animals, humans, balls or other substances. Simply put, the object may move to any position in the surrounding environment and the second camera module 18 traces the position where the object moves. The local image compensates the unclear image in the full view image.

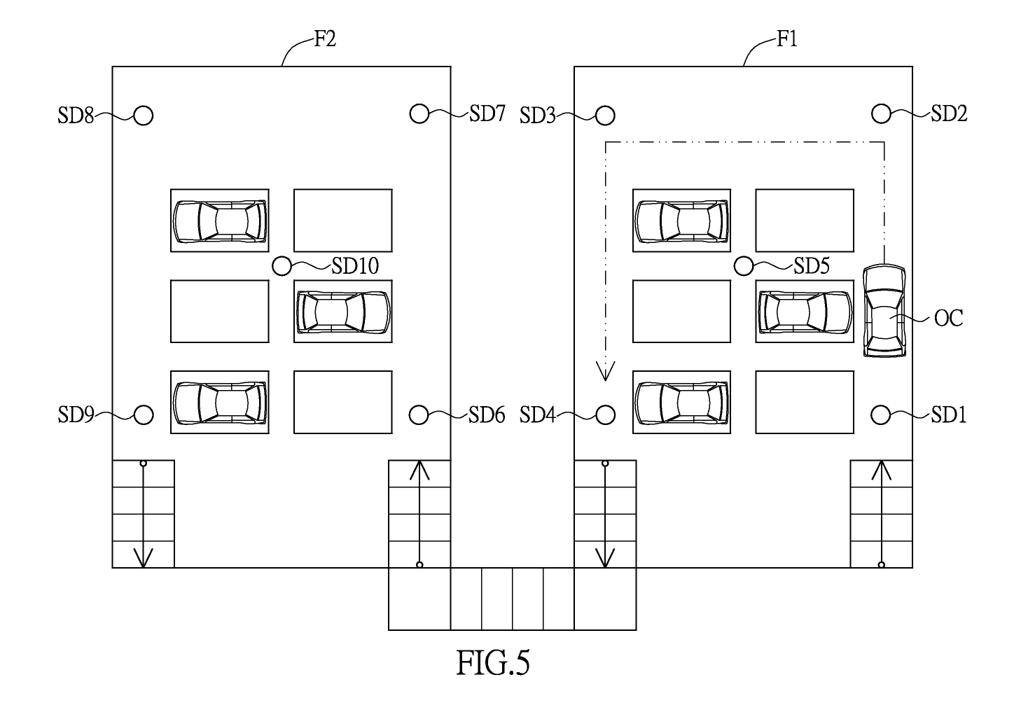

FIG. 5 is a schematic view of how a surveillance system operates according to one embodiment of the present invention. With reference to FIG. 5, the surveillance system includes a host (not shown) and a plurality of surveillance devices SD1˜SD10. Practically, the host is coupled to a network. The plurality of surveillance devices SD1˜SD10 are coupled, respectively, to the host. The plurality of surveillance devices SD1˜SD10 are installed, respectively, in a plurality of zones in a surveillance environment. To make it more clearly understood, in the present embodiment, a parking garage including two floors F1 and F2 is described as an example. Each of the floors F1, F2 are provided with five surveillance devices SD1˜SD5, SD6˜SD10, as shown in FIG. 5.

More particularly, the host transmits a surveillance data to the plurality of surveillance devices SD1˜SD10. When one of the plurality of surveillance devices SD1˜SD10 uses the second camera module to acquire an identification data of the object OC, the processing module compares the identification data with the surveillance data. One of the plurality of surveillance devices SD1˜SD10 detects the object OC when the processing module determines that the identification data matches the surveillance data. When one of the plurality of surveillance devices SD1˜SD10 detects an object OC, the one of the plurality of surveillance devices SD1˜SD10 that detects the object OC outputs a detection signal to the host. The host controls the plurality of surveillance devices SD1˜SD10, respectively, to surveil the object OC according to a moving path of the object OC.

The surveillance data is, for example, a license plate number of a vehicle, while the identification data is, for example, the license plate image. Accordingly, when a vehicle is going to enter the parking garage, the surveillance device SD1 uses the second camera module to acquire the license plate image of the vehicle. The processing module compares the license plate image with the license plate number. If the processing module determines that the license plate image matches the license plate number, the surveillance device SD1 outputs a detection signal to the host. Thereby, the host controls the plurality of surveillance devices SD1˜SD5 to surveil the vehicle in turn according to the moving path of the vehicle.

Moreover, the host is informed that the parking space of the vehicle is on the 2nd floor F2 according to the detection signal. Accordingly, when the surveillance device SD4 traces that the vehicle is driving up to the 2nd floor F2, the second camera module of the surveillance device SD4 uses the second rotation unit to record a video of the vehicle entering the climbing lane. Then, the host controls the surveillance device SD6 on the 2nd floor F2 to trace the vehicle.

Then, the second camera module of the surveillance device SD6 uses the second rotation unit to record a video of the vehicle coming from the climbing lane. The host controls the plurality of surveillance devices SD6˜SD10 to surveil the vehicle in turn according to the moving path of the vehicle. The present invention is, however, not limited to the previous examples of how the surveillance system operates.

In other embodiments, each of the surveillance devices SD1˜SD10 further includes an identification module (not shown) for wirelessly identifying an identification chip (not shown) attached on the object OC. When one of the plurality of surveillance devices SD1˜SD10 identifies the identification chip attached on the object OC, the one of the plurality of surveillance devices SD1˜SD10 that identifies the identification chip outputs an identification signal to the host, and the host controls the plurality of surveillance devices SD1˜SD10, respectively, to surveil the object OC according to the moving path of the object OC.

The identification module is implemented, for example, by RFID technology, Wi-Fi technology, Blue-Tooth communication technology or other wireless communication technologies. The present invention is, however, not limited to the previous examples of the identification module. If a vehicle is provided with an identification chip capable of communicating with the identification module, the surveillance device SD1 uses the identification module to wirelessly identify the identification chip on the vehicle when the vehicle enters the parking garage. The identification chip is implemented by a parking license, a bracelet or the like. When the surveillance device SD1 identifies the identification chip on the vehicle, the surveillance device SD1 outputs an identification signal to the host so that the host controls the plurality of surveillance devices SD1˜SD10 to surveil the vehicle in turn according to the moving path of the vehicle.

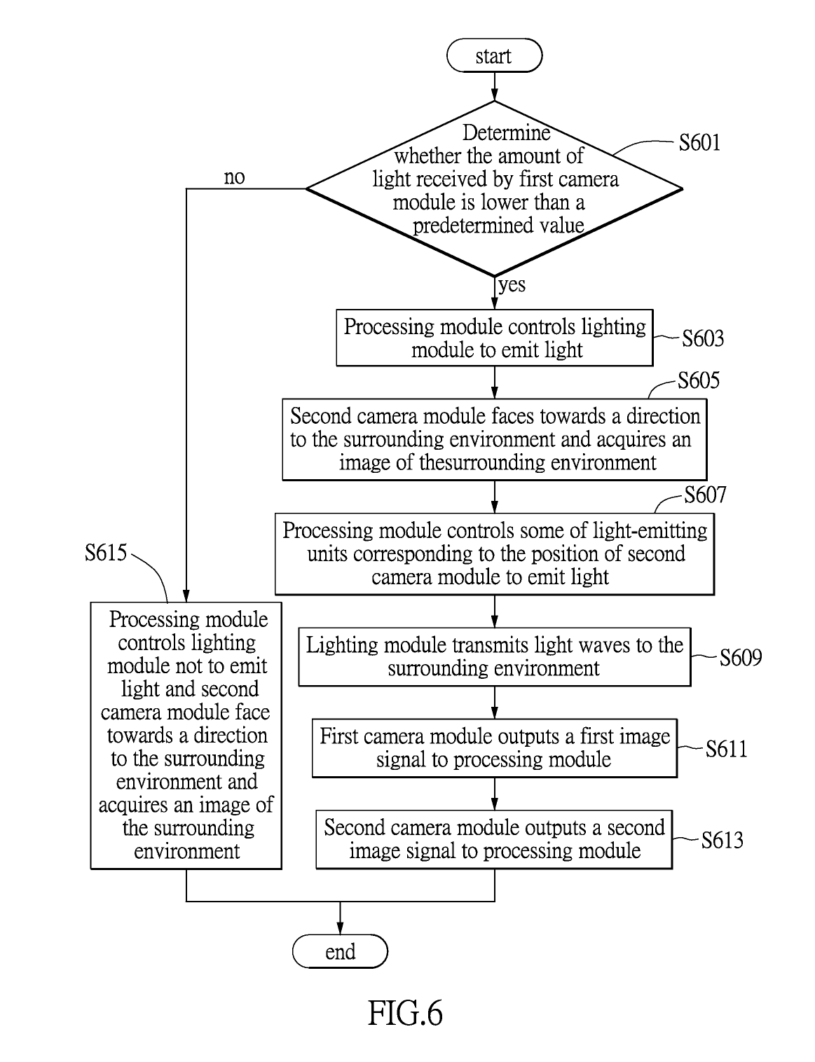

FIG. 6 is a flowchart of a surveillance method according to one embodiment of the present invention. With reference to FIG. 6, the present invention provides a surveillance method for a surveillance device. The surveillance device includes a processing module, a lighting module, a movable module, a first camera module and a second camera module. The processing module is coupled to the lighting module, the movable module, the first camera module and the second camera module. The surveillance method includes the steps herein.

In Step S601, whether the amount of light received by the first camera module is lower than a predetermined value is determined. Practically, there is sufficient amount of light in the day time. On the contrary, the amount of light is insufficient during the night time. In the present embodiment, a predetermined value is referenced to distinguish the high and low of the amount of light, for example, in the day time and the night time. Accordingly, the surveillance device may acquire images both in the day time and in the night time or under conditions of insufficient light.

If the amount of light received by the first camera module is determined to be lower than the predetermined value in Step S601, Step S603 is performed so that the processing module controls the lighting module to emit light. Then, in Step S605, the processing module uses the movable module to control the second camera module to face towards a direction to the surrounding environment so that the second camera module acquires an image of the surrounding environment. In other words, when the processing module controls the movable module to move or rotate so that the second camera module face towards the surrounding environment, the processing module controls the lighting module to emit light to illuminate the surrounding environment and the second camera module zooms to acquire the image of the surrounding environment.

In Step S607, the processing module controls some of the light-emitting units corresponding to the position of the second camera module to emit light according to the position of the second camera 18. Practically, the lighting module comprises a plurality of light-emitting units disposed on the outer side of the base. It will cause a waste of energy if all of the plurality of light-emitting units emit light. Accordingly, in the present embodiment, only some of the light-emitting units corresponding to the position that the second camera module faces emit light.

Next, in Step S609, the lighting module transmits light waves to the surrounding environment. The surrounding environment reflects the light waves. In Step S611, the first camera module receives the reflected light waves and outputs a first image signal to the processing module. In Step S613, the second camera module receives the reflected light waves and outputs a second image signal to the processing module.

For example, in a surrounding environment with 360° panorama, if the second camera module faces towards the surrounding environment at 120°, the light-emitting unit corresponding to the direction at 120° emits light to illuminate the surrounding environment at 120°. Accordingly, in the night time or under conditions of insufficient light, the light-emitting unit such as an infrared (IR) transmitter transmits IR light waves to the surrounding environment so that the first and the second camera modules acquire the full view image or the local image of the surrounding environment.

If the amount of light received by the first camera module is determined to be higher than the predetermined value in Step S601, Step S615 is performed so that the processing module controls the lighting module not to emit light. The processing module uses the movable module to control the second camera module to face towards a direction to the surrounding environment so that the second camera module zooms to acquire an image of the surrounding environment. In other words, the lighting module does not emit light to the surrounding environment. The processing module uses the movable module to control the second camera module to face towards the direction surrounding environment so that second camera module acquires the image of the surrounding environment.

It should be noted that, in other embodiments, the surveillance device may also include a positioning module and an identification module. More particularly, the positioning module is provided with a reference origin. The processing module controls the movable module to move and controls the corresponding lighting module to emit light according to the coordinate system of the reference origin. Otherwise, the positioning module outputs a positioning signal to the processing module according to the position of the second camera module so that the processing module acquires the position of the second camera module.

Moreover, the identification module wirelessly identifies the identification chip of the object. When one of the plurality of surveillance devices identifies the identification chip of the object, the surveillance device that identifies the identification chip outputs an identification signal to the host. The host controls the plurality of surveillance devices, respectively, to surveil the object according to the moving path of the object. The foregoing steps of the positioning module and the identification module may also be added to the flowchart of the surveillance method in FIG. 6. The present invention is, however, not limited to the previous steps of the surveillance method.

As stated above, the present invention provides a surveillance device. When the amount of light received by the first camera module is lower than a predetermined value, the processing module controls the lighting module to emit light. The processing module controls some of the light-emitting units corresponding to the position of the second camera module to emit light according to the position of the second camera module. More particularly, the lighting module transmits infrared light waves to the surrounding environment so that the first and the second camera modules are able to acquire a full view image and a local image in the night time or under conditions of insufficient light. Moreover, the first camera module statically acquires the full view image of the surrounding environment, and the second camera module dynamically acquires the local image of the surrounding environment. More particularly, the surrounding environment or the object in the full view image can be enlarged in the local image so as to compensate the unclear image in the full view image. Accordingly, with the use of the present invention, the targeted object can be traced to acquire the local image and the full view image of the targeted object in the environment. As a result, surveillance and security can be enhanced.

The above-mentioned descriptions represent merely the exemplary embodiment of the present disclosure, without any intention to limit the scope of the present disclosure thereto. Various equivalent changes, alterations or modifications based on the claims of present disclosure are all consequently viewed as being embraced by the scope of the present disclosure.

What is claimed is:

1. A surveillance device, comprising:
a processing module;
a lighting module coupled to said processing module to emit light and illuminate a surrounding environment;
a movable module coupled to said processing module;
a first camera module coupled to said processing module; and
a second camera module coupled to said processing module and disposed on said movable module;
wherein, when said processing module determines that an amount of light received by said first camera module is lower than a predetermined value, said processing module controls said lighting module to emit light and said processing module uses said movable module to control said second camera module to acquire a direction to said surrounding environment so that said second camera module faces towards said direction to acquire an image of said surrounding environment.

2. The surveillance device of claim 1, further comprising:
a base;
a support connecting said base; and
a cover connecting said base, said cover enclosing a compartment;
wherein, said lighting module is disposed on an outer side of said base, said first camera module is disposed on a top portion of said support, and said compartment enclosed by said cover accommodates said first camera module, said second camera module and said movable module.

3. The surveillance device of claim 1, wherein said lighting module is an infrared (IR) transmitter, a white light transmitter, a yellow light transmitter, a blue light transmitter or a green light transmitter, said lighting module transmits light waves to said surrounding environment so that said first camera module transmits a first image signal to said processing module and said second camera module transmits a second image signal to said processing module when said first camera module and said second camera module receive said light waves reflected by said surrounding environment.

4. The surveillance device of claim 2, wherein said lighting module is an infrared (IR) transmitter, a white light transmitter, a yellow light transmitter, a blue light transmitter or a green light transmitter, said lighting module transmits light waves to said surrounding environment so that said first camera module transmits a first image signal to said processing module and said second camera module transmits a second image signal to said processing module when said first camera module and said second camera module receive said light waves reflected by said surrounding environment.

5. The surveillance device of claim 3, wherein said lighting module comprises a plurality of light-emitting units disposed on an outer side of said base, and said processing module controls at least one of said plurality of light-emitting units to emit light corresponding to a position of said second camera module according to said position of said second camera module.

6. The surveillance device of claim 4, wherein said lighting module comprises a plurality of light-emitting units disposed on an outer side of said base, and said processing module controls at least one of said plurality of light-emitting units to emit light corresponding to a position of said second camera module according to said position of said second camera module.

7. The surveillance device of claim 1, wherein said first camera module acquires a full view image of said surrounding environment, said second camera module zooms to acquire a local image of said surrounding environment, said first camera module is provided with a first shooting angle, said second camera module is provided with a second shooting angle, and said first shooting angle is wider than said second shooting angle.

8. The surveillance device of claim 2, wherein said first camera module acquires a full view image of said surrounding environment, said second camera module zooms to acquire a local image of said surrounding environment, said first camera module is provided with a first shooting angle, said second camera module is provided with a second shooting angle, and said first shooting angle is wider than said second shooting angle.

9. The surveillance device of claim 1, wherein said first camera module comprises a fish-eye unit and a filter switching unit being connected to each other so that said processing module controls said filter switching unit to block infrared (IR) from entering when light with said amount being higher than or equal to said predetermined value enters said fish-eye unit, and said processing module controls said filter switching unit to allow infrared (IR) to enter when light with said amount being lower than said predetermined value enters said fish-eye unit.

10. The surveillance device of claim 2, wherein said first camera module comprises a fish-eye unit and a filter switching unit being connected to each other so that said processing module controls said filter switching unit to block infrared (IR) from entering when light with said amount being higher than or equal to said predetermined value enters said fish-eye unit, and said processing module controls said filter switching unit to allow infrared (IR) to enter when light with said amount being lower than said predetermined value enters said fish-eye unit.

11. The surveillance device of claim 2, wherein said movable module comprises a first rotation unit and a second rotation unit, said first rotation unit rotating clockwise or counter clockwise with respect to said support as a rotational axis so that said second camera module moves or rotates with respect to said support, said second rotation unit rotating upwards or downwards so that said second camera module rotates upwards or downwards.

12. The surveillance device of claim 1, further comprising a positioning module coupled to said processing module, said positioning module being provided with a reference origin, and said positioning module outputting a positioning signal to said processing module according to a position of said second camera module so that said processing module acquires said position of said second camera module.

13. The surveillance device of claim 2, further comprising a positioning module coupled to said processing module, said positioning module being provided with a reference origin, and said positioning module outputting a positioning signal to said processing module according to a position of said second camera module so that said processing module acquires said position of said second camera module.

14. The surveillance device of claim 1, wherein said processing module is provided with a positioned cruising mode, a cruising mode and a non-cruising mode, and said processing module controls said movable module to move or rotate according to said positioned cruising mode, said cruising mode or said non-cruising mode so that said second camera module faces towards said surrounding environment.

15. The surveillance device of claim 2, wherein said processing module is provided with a positioned cruising mode, a cruising mode and a non-cruising mode, and said processing module controls said movable module to move or rotate according to said positioned cruising mode, said cruising mode or said non-cruising mode so that said second camera module faces towards said surrounding environment.

16. A surveillance system, comprising:
a host coupled to a network; and
a plurality of surveillance devices of claim 1 coupled to said host, said plurality of surveillance devices being disposed, respectively, in a plurality of zones in a surveillance environment;
wherein, when one of said plurality of surveillance devices detects an object, said one of said plurality of surveillance devices that detects said object outputs a detection signal to said host so that said host controls said plurality of surveillance devices, respectively, to surveil said object according to a moving path of said object.

17. The surveillance system of claim 16, wherein said host transmits a surveillance data to said plurality of surveillance devices so that said processing module compares an identification data of said object with said surveillance data when said one of said plurality of surveillance devices acquires said identification data from said second camera module and said one of said plurality of surveillance devices detects said object when said processing module determines that said identification data matches said surveillance data.

18. The surveillance system of claim 16, wherein each of said surveillance devices further comprises an identification module for wirelessly identifying an identification chip attached on said object so that, when said one of said plurality of surveillance devices identifies said identification chip attached on said object, said one of said plurality of surveillance devices that identifies said identification chip outputs an identification signal to said host, and said host controls said plurality of surveillance devices, respectively, to surveil said object according to said moving path of said object.

19. A surveillance method for a surveillance device, said surveillance device comprising a processing module, a lighting module, a movable module, a first camera module and a second camera module, said processing module being coupled to said lighting module, said movable module, said first camera module and said second camera module, said surveillance method comprising:
determining whether an amount of light received by said first camera module is lower than a predetermined value so that
when said amount of light received by said first camera module is lower than said predetermined value, said processing module controls said lighting module to emit light and said processing module uses said movable module to control said second camera module to face towards a direction to said surrounding environment so that said second camera module acquires an image of said surrounding environment, or
when said amount of light received by said first camera module is higher than said predetermined value, said processing module controls said lighting module not to emit light and said processing module uses said movable module to control said second camera module to face towards said direction to said surrounding environment so that said second camera module acquires said image of said surrounding environment.

20. The surveillance method of claim 19, wherein the step that said processing module controls said lighting module to emit light further comprises:
transmitting, by said lighting module, light waves to said surrounding environment;
transmitting, by said first camera module, a first image signal to said processing module when said first camera module receives said light waves reflected by said surrounding environment; and
transmitting, by said second camera module, a second image signal to said processing module when said second camera module receives said light waves reflected by said surrounding environment.

21. The surveillance method of claim 19, wherein said lighting module comprises a plurality of light-emitting units disposed on an outer side of said base, and the step that said processing module controls said lighting module further comprises:
controlling, by said processing module, at least one of said plurality of light-emitting units corresponding to a position of said second camera module to emit light according to said position of said second camera module.
